(19) United States
(12) Patent Application Publication
(10) Pub. No.: US 2007/0272401 A1
(43) Pub. Date: Nov. 29, 2007

(54) Climate control

(76) Inventor: Theodoros Asimakupoulos, Wheaton, MD (US)

Correspondence Address: Theodoros Asimakupoulos, 3703 Jeffrey St, Wheaton, MD, 20906, US

(21) Appl. No.: 11/441,875

(22) Filed: May 26, 2006

(51) Int. Cl. B60H 1/00; G05D 23/19; G05D 23/32

(52) U.S. Cl. 165/202; 165/238; 62/157

(57) ABSTRACT

New service that allows climate to be set to time in vehicle. Meaning you Set time and climate setting and heat, air conditioning, etc and the climate Comes on.

### CROSS REFERENCE TO RELATED APPLICATIONS

Not applicable

### FIELD OF THE INVENTION

This invention allows the climate to be used with an alarm clock feature.

### BACKGROUND OF THE INVENTION

Entering vehicle and having to wait for heat or other type of climate is a Thing of the past. With this new advancement, when entering vehicle the Climate is on to the time person sets the climate to be on.

### SUMMARY OF THE INVENTION

Climate is set to stored time that climate is to be turned on. So when Entering the vehicle, the climate is on.

What is claimed:

1. Climate in vehicle is turned on by a digital alarm clock. Setting the climate to a certain degree including vent and defrost to be turned on by a saved time digitally.

2. When climate settings are turned on there is a signal sent to engine that enables engine to power climate.
